(19) United States
(12) Patent Application Publication
(10) Pub. No.: US 2015/0012142 A1
(43) Pub. Date: Jan. 8, 2015

(54) DISPLAYING DEVICE AND METHOD

(71) Applicant: Azbil Corporation, Tokyo (JP)

(72) Inventor: Kei KOGA, Tokyo (JP)

(73) Assignee: AZBIL CORPORATION, Tokyo (JP)

(21) Appl. No.: 14/323,245

(22) Filed: Jul. 3, 2014

(30) Foreign Application Priority Data
Jul. 5, 2013 (JP) 2013-141313

(51) Int. Cl. G05D 23/19; G06F 3/0484

(52) U.S. Cl. CPC G05D 23/1917; G06F 3/0484
USPC 700/276

(57) ABSTRACT

A displaying device used in an air-conditioning system includes a blowing vent with a variable airflow direction, that blows conditioned air, as supply air, into a subject space that is subject to air-conditioning, an occupant location detecting unit that detects a location of an occupant within the subject space, a controller that predicts, following a guideline that has been established in advance, an arrival region for the supply air so as to include the location of an occupant detected by the occupant location detecting unit, and adjusts at least a flow direction of the blowing vent so as to include the location of an occupant detected by the occupant location detecting unit, and a display that displays simultaneously, on a screen, the occupant location detected by the occupant location detecting unit and a predicted supply air arrival region, predicted by the controller.

### CROSS REFERENCE TO RELATED APPLICATION

This application claims priority under 35 U.S.C. §119 to Japanese Patent Application No. 2013-141313, filed on Jul. 5, 2013, the entire content of which being hereby incorporated herein by reference.

### FIELD OF TECHNOLOGY

The present invention relates to a displaying device and method used in an air-conditioning system.

### BACKGROUND

FIG. 10 illustrates one example a conventional air-conditioning system, referencing, for example, Japanese Unexamined Patent Application Publication 2005-221208. In this figure, 1 is an air conditioner, 2 is a controller that is attached to the air conditioner 1, 3 is a subject space that is subject to air-conditioning control, to which air that has been conditioned is supplied from the air conditioner 1, and 4 is a blowing vent for blowing the conditioned air (supply air) from the air conditioner 1 into the subject space 3 that is subject to air-conditioning control, where the blowing vent 4 is a blowing vent wherein the direction of air flow can be varied. While, in the following, a subject space that is subject to air-conditioning control shall be termed a “subject space,” all instances of “subject space” shall refer to spaces that are subject to air-conditioning control.

A cold water coil 1A, a hot water coil 1B, and a blower (a supply air fan) 1C are provided in the air conditioner 1. Moreover, a cold water valve 5 is provided in the supply route of cold water CW to the cold water coil 1A, and a hot water valve 6 is provided in the supply path of hot water to the hot water coil 1B. Additionally, the blowing vent 4, wherein the direction of air flow can be varied, is provided with a supply air temperature sensor 7 for detecting a temperature (the supply air temperature) is of the supply air that is blown into the subject space 3, and a supply air flow rate sensor 8 for detecting the flow rate (the supply air flow rate) W of the supply air that is blown into the subject space 3. Moreover, a temperature sensor 9 for detecting, as the room temperature tr, the temperature within the subject space 3, and an occupant location detecting sensor 10, for detecting, as M(x, y) the location of an occupant within the subject space 3, are provided in the subject space 3 that is subject to air-conditioning control.

In this air-conditioning system, the controller 2 has a function for predicting, following guidelines that have been established in advance, the region at which supply air will arrive, and for adjusting at least the direction of the airflow of the blowing vent 4 so as to achieve the predicted supply air arrival region, so as to include the location M(x, y) of the occupant that is detected by the occupant location detecting sensor 10.

For example, the controller 2 predicts a supply air arrival region SP (for example, a region that is within the supply air temperature (set point value tss)±x° C.) that includes the occupant location M(x, y) using a predictive model MD that is established in advance, and adjusts a supply air blowing angle θ from the blowing vent 4 so as to produce the predicted supply air arrival region SP. Additionally, if the predicted supply air arrival region SP cannot be produced by adjusting the blowing angle θ alone, then the flow rate W of the supply air from the blowing vent 4, the temperature ts of the supply air from the blowing vent 4, or the like, is also adjusted.

Note that in this invention the adjustment of the blowing angle 0 of the supply air from the blowing vent 4 is performed through controlling the operation of an actuator (not shown) that is provided in the blowing vent 4, where the adjustment of the flow rate W of the supply air from the blowing vent 4 is performed through controlling the speed of rotation of a supply air fan 1C, and the adjustment of the temperature ts of the supply air from the blowing vent 4 is performed through controlling the degree of opening of a cold water valve 5 or a hot water valve 6.

However, in a conventional air-conditioning system, illustrated in FIG. 10, there is a problem in that the occupant will be uncomfortable or excessive energy will be consumed if the system is not operated properly.

For example, if the occupant location detecting sensor 10 is not operating properly, then the actual supply air arrival region SR will be at a location other than that of the occupant, as illustrated in FIG. 11, for example, causing the occupant to be uncomfortable. Moreover, this wastes energy as well.

Moreover, even if the occupant location detecting sensor 10 is operating properly, still the actual supply air arrival region SR may be other than the location of the occupant, for reasons such as a problem with the air-conditioning equipment (an actuator controlling the airflow direction, airflow rate, supply air temperature, or the like), tolerance error in the predictive model MD (effects caused by the layout of the room), or the like.

When such a situation occurs, then the maintenance technician, building supervisor, or the like performs on-site checks on the operation of the air-conditioning system. However, conventionally, it has been difficult to evaluate whether or not the system is operating properly, and if not operating properly, the work of tracing back the cause of the problems has been extremely difficult, and has required excessive operating expenditures. Moreover, even if the error is found, this has also had the potential of requiring further operating expenditures.

The present invention was created to solve such issues, and an aspect thereof is to provide a displaying device and method that facilitates evaluation of whether or not an air-conditioning system is operating properly, and that also aids in the task of tracing back the causes if the system is not operating properly.

### SUMMARY

In order to achieve the aspect set forth above, the present invention is a displaying device used in an air-conditioning system including a blowing vent with a variable airflow direction, that blows conditioned air, as supply air, into a subject space that is subject to air-conditioning, an occupant location detecting unit that detects a location of an occupant within the subject space, and a controller that predicts, following a guideline that has been established in advance, an arrival region for the supply air so as to include a location of an occupant detected by the occupant location detecting unit, and adjusts at least a flow direction of the blowing vent so as to include a location of an occupant detected by the occupant location detecting unit. The displaying device further includes a display displays simultaneously, on a screen, the occupant location detected by the occupant location detecting unit and a predicted supply air arrival region, predicted by the controller.

The inventor realized that, in regards to the problems that are to be resolved in the conventional air-conditioning systems, one of the causes of these problems is the difficulty in ascertaining the state intended by the controller when performing control. That is, the inventor realized that this is difficult to do in a state wherein the controller has no suitable imaging device for creating spatially an image of (1) the location wherein an occupant has been detected and (2) what region is to be made comfortable, and because of this, so it is not possible to ascertain immediately whether or not the current state of the environment is that which is intended by the controller. Given this, the inventor arrived at the conclusion that if the location wherein the occupant was detected and the predicted supply air arrival region were displayed simultaneously on a screen, then it would be possible to ascertain the intention of the controller at a glance, facilitating an evaluation as to whether or not the air-conditioning system is operating properly, and also facilitating the work of tracing back the cause if the system is not operating properly.

In the present invention, whether or not the occupant location detecting unit is operating properly can be checked by comparing the location of an occupant as displayed on the screen versus the actual location of the occupant. If the occupant location detecting unit is not operating properly, then it will be understood that that is one reason why the actual supply air arrival region is incorrect.

Moreover, if the occupant location detecting unit are operating properly but the actual supply air arrival region is greatly different from the predicted supply air arrival region that is displayed on the screen, then it can be understood that one reason for the actual supply air arrival region being incorrect is that there is a problem with the air-conditioning equipment (such as in an actuator for controlling the airflow direction, the airflow rate, the supply air temperature, or the like), or that there is large modeling error in the predictive model due to the layout of the room, or the like.

Moreover, if the location of the occupant and the predicted supply air arrival region that are displayed on the screen are both correct, and, despite that, the actual supply air arrival region is considered to be incorrect, then it will be understood that there is a high probability that there is a problem in the control algorithm.

Given the present invention, the display is provided for displaying, simultaneously on a screen, a location of an occupant who is detected by the occupant location detecting unit, and a predicted supply air arrival region, predicted by a controller, and thus the location at which the occupant is detected and the predicted supply air arrival region are displayed simultaneously on the screen, thus facilitating the evaluation of whether or not the air-conditioning system is operating properly, and facilitating the work of tracing back the cause if the system is not operating properly.

### BRIEF DESCRIPTIONS OF THE DRAWINGS

FIG. 1 is a diagram illustrating the critical portions of an air-conditioning system that uses an example of a displaying device according to the present disclosure.

FIG. 2 is a diagram illustrating the state wherein the actual supply air arrival region is away from the location of the occupant in this air-conditioning system.

FIG. 3 is a diagram illustrating an exemplary display on the screen of the displaying device in the air-conditioning system.

FIG. 4 is a diagram illustrating an exemplary display on the screen of the displaying device in the air-conditioning system.

FIG. 5 is a diagram illustrating yet another exemplary display on the screen of the displaying device in the air-conditioning system.

FIG. 6 is a diagram displaying an example of a display on the screen when there is a plurality of blowing vents.

FIG. 7 is a diagram illustrating an example wherein an average temperature of a predicted supply air arrival region is displayed on the screen.

FIG. 8 is a diagram illustrating an example wherein the flow rate, flow speed, and flow direction of the supply air from a blowing vent are displayed.

FIG. 9 is a diagram presenting an example of time-series data that includes the location of occupants that have been detected by the occupant location sensor, for each blowing vent, and the predicted supply air arrival regions predicted by the controller.

FIG. 10 is a diagram illustrating one example of a conventional air-conditioning system.

FIG. 11 is a diagram illustrating the state wherein the actual supply air arrival region is away from the location of the occupant in this air-conditioning system.

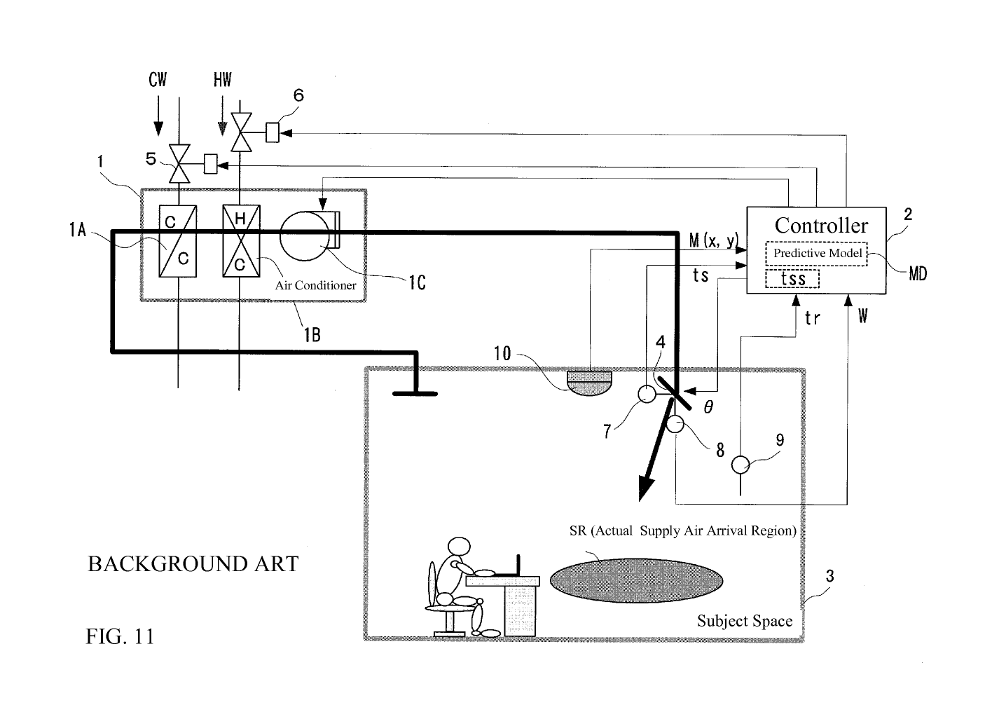

### DETAILED DESCRIPTION

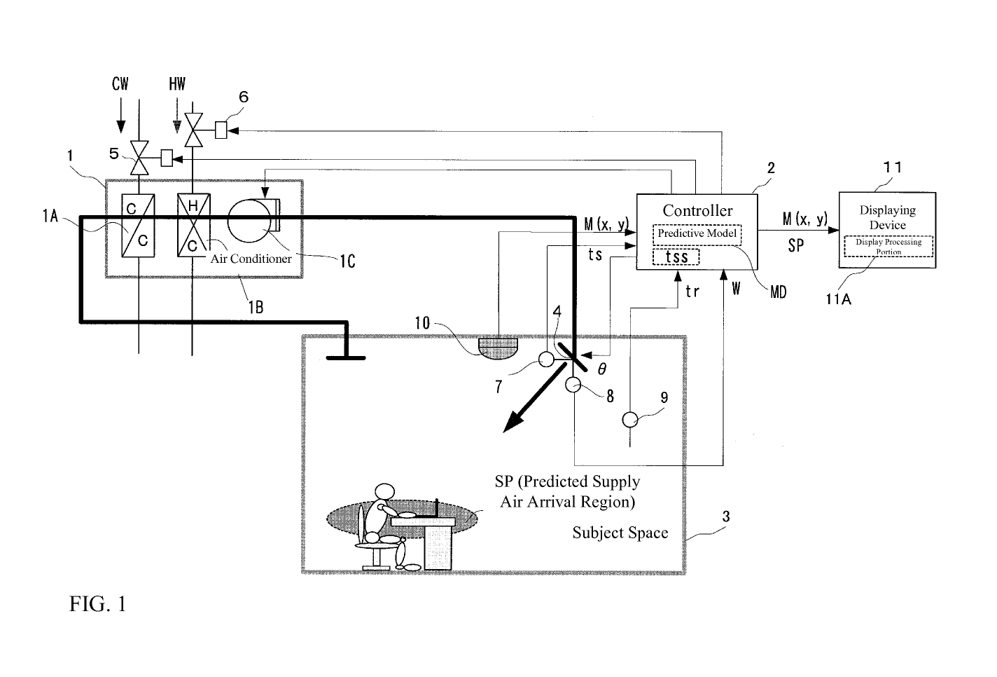

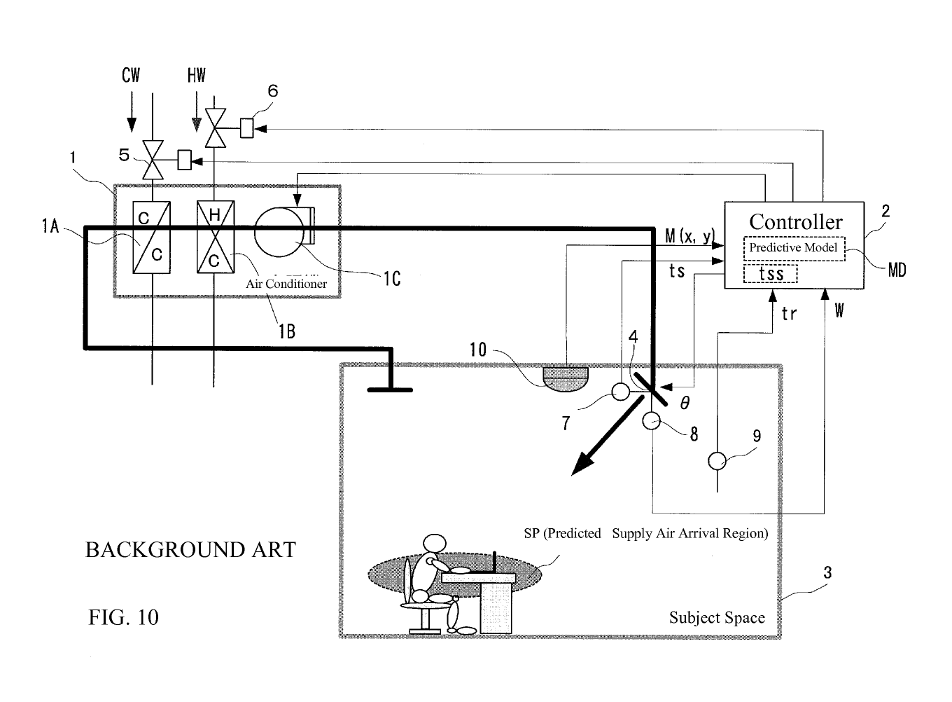

The present disclosure will be explained in detail below based on the drawings. FIG. 1 is a diagram illustrating the critical portions of an air-conditioning system that uses an example of a displaying device according to the present disclosure. In this figure, codes that are the same as those in FIG. 10 indicate identical or equivalent structural elements as the structural elements explained in reference to FIG. 10, and explanations thereof are omitted.

In this air-conditioning system, the point of difference from the conventional air-conditioning system is in the provision of the displaying device 11, as an example of the displaying device according to the present disclosure, in the controller 2.

The displaying device 11 is embodied through hardware, including a processor and a storage device, and a program that causes a variety of functions to be achieved in cooperation with this hardware. Specifically, a program is installed in a computer, and the invention is embodied as processing operations by the CPU following the installed program.

In the present example, the controller 2 sends, to the displaying device 11, an occupant location M(x, y) that is detected by the occupant location detecting sensor 10, and a predicted supply air arrival region SP that has been predicted. The displaying device 11 displays simultaneously, on a screen, the occupant location M(x, y) that was detected by the occupant location detecting sensor 10, which has been sent by the controller 2, and the predicted supply air arrival region SP that has been predicted by the controller 2.

Note that while in the present example a predictive model MD is used to predict a supply air arrival region (a predicted supply air arrival region) SP that includes the location M(x, y) of the occupant, the method for predicting the supply air arrival region is not limited to the use of a predictive model MD, but rather any method may be used for making the prediction.

In the present example, in the controller 2, a predictive model MD is used that uses as parameters the blowing angle and blowing air flow speed, the distance from the blowing vent to the occupied region, the supply air temperature, the room temperature, and the like, to predict an arrival region for the supply air (a region that is within the supply air temperature (set point temperature tss)±x° C.) as the predicted supply air arrival region SP so as to include the location M(x, y) of the occupant while varying the parameter values such as the blowing angle, the blowing air flow speed, the supply air temperature, and the like. For example, if the predicted supply air arrival region SP is assumed to be an ellipse, then equations for predicting the center point, the major and minor axes, and the orientation of the ellipse would be produced. If, for example, simulations (through CFD (Competition Fluid Dynamics), or the like) are performed during the development stage, then the predictive model MD may be produced from the resulting data.

### Operational Checks

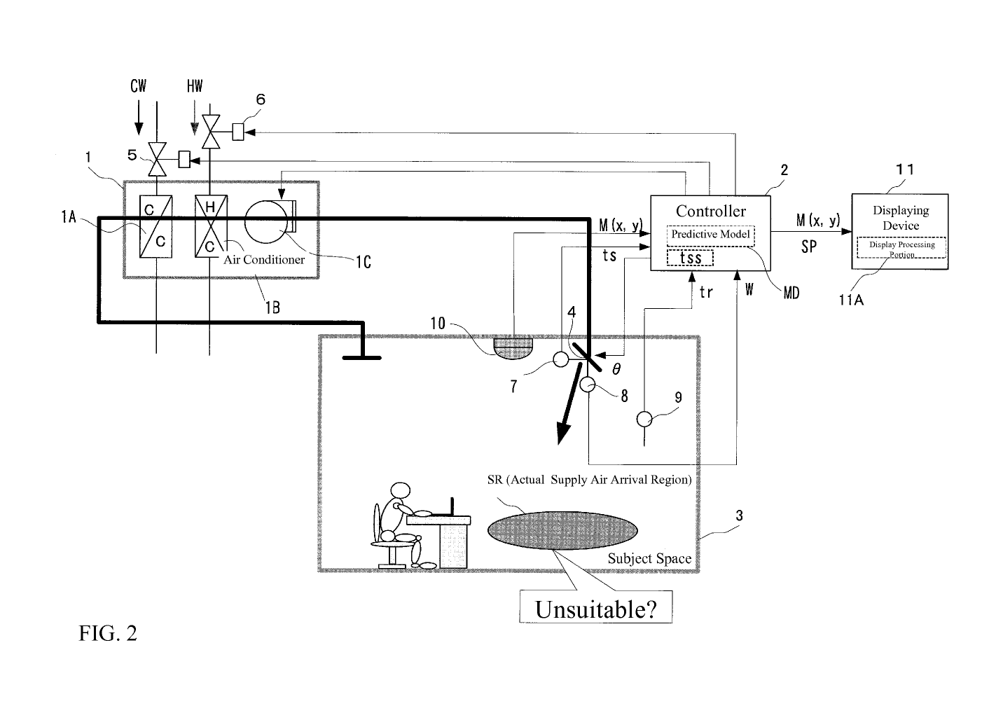

As an example, let us consider a case wherein the actual supply air arrival region SR is away from the location of the occupant, so might be considered to be inappropriate, as illustrated in FIG. 2. In this case, the maintenance technician or building supervisor, or the like, operates the displaying device 11 to display a control screen for the subject space 3 that is subject to air-conditioning control.

At this time, the displaying device 11 displays simultaneously, on the control screen, the location M(x, y) of the occupant, detected by the occupant location detecting sensor 10, and the predicted supply air arrival region SP, predicted by the controller 2.

### Exemplary Display

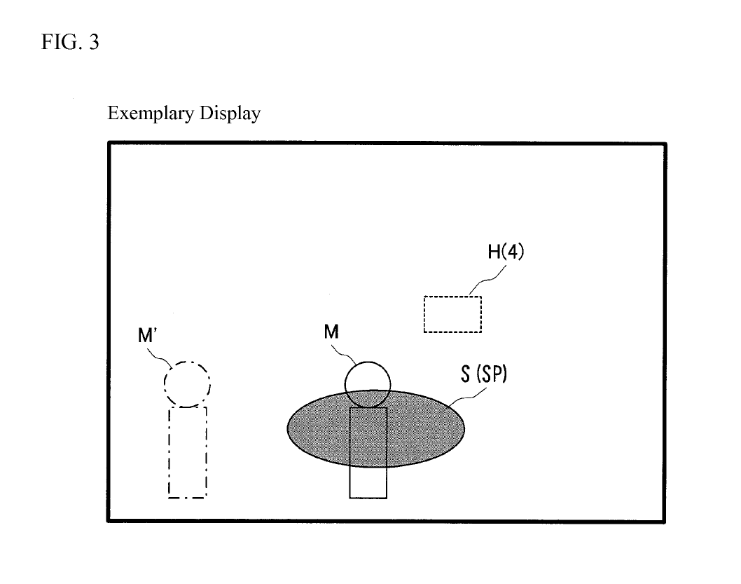

FIG. 3 illustrates a case, as an exemplary display, wherein an occupant is shown even though there is actually no occupant. In FIG. 3, M, which is indicated by the solid line, shows the location of the occupant that is detected by the occupant location detecting sensor 10, and M′, indicated by the dotted line, shows the actual location of the occupant. Moreover, the elliptical region S, indicated by the solid line, shows the predicted supply air arrival region SP that has been predicted by the controller 2. The square shape H, indicated by the dotted lines, shows a blowing vent 4.

In the exemplary display, M′ (the actual location of the occupant), indicated by the dotted line, is not displayed on the screen. M (the location of an occupant that is detected by the occupant location detecting sensor 10), indicated by the solid line, the elliptical region S (the predicted supply air arrival region SP, predicted by the controller 2), indicated by the solid line, and the square H (the blowing vent 4), indicated by the dotted line, are displayed.

The exemplary display makes it possible to check whether or not the occupant location detecting sensor 10 is operating properly, by comparing the occupant location M that is displayed on the screen versus the actual occupant location M′. In this case, the occupant location detecting sensor 10 detects the location of the occupant incorrectly, so it is understood that there is a probability that the actual supply air arrival region SR is unsuitable.

### Another Exemplary Display

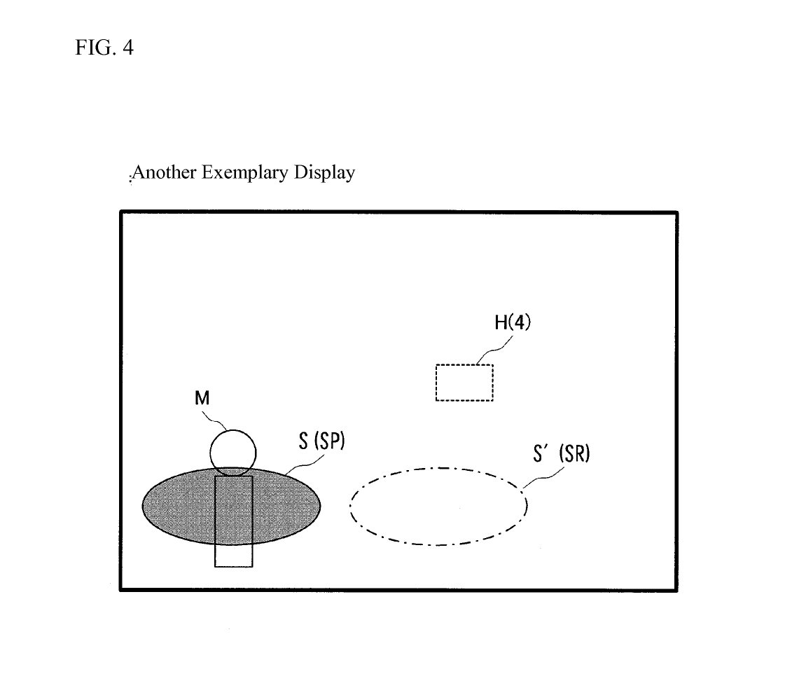

FIG. 4 shows a case, as another exemplary display, wherein the occupant location detecting sensor 10 is operating properly, but there is a large error between the actual supply air arrival region SR and the supply air arrival region S that is displayed (the predicted supply air arrival region SP, predicted by the controller 2). In FIG. 4, the elliptical region S′, indicated by the dotted line, shows the actual supply air arrival region SR.

In the another exemplary display, the elliptical region S′ (the actual supply air arrival region SR), indicated by the dotted line, is not displayed on the screen. M (the location of an occupant that is detected by the occupant location detecting sensor 10), indicated by the solid line, the elliptical region S (the predicted supply air arrival region SP, predicted by the controller 2), indicated by the solid line, and the square H (the blowing vent 4), indicated by the dotted line, are displayed.

In the another exemplary display, the occupant location M that is displayed on the screen is the same as the actual occupant location, so it is understood that the occupant location detecting sensor 10 is operating properly. In contrast, there is a large discrepancy between the elliptical region S′ (the actual supply air arrival region SR), indicated by the dotted line, and the elliptical region S (the predicted supply air arrival region SP, predicted by the controller 2), indicated by the solid line.

From this it is understood that it is possible that the actual supply air arrival region SR is in an unsuitable location, caused by a problem with the air-conditioning equipment (for example, an actuator for controlling the air flow direction, the air flow rate, the supply air temperature, or the like), or the modeling error in the predictive model MD having become large due to the layout of the room, or the like.

### Yet Another Exemplary Display

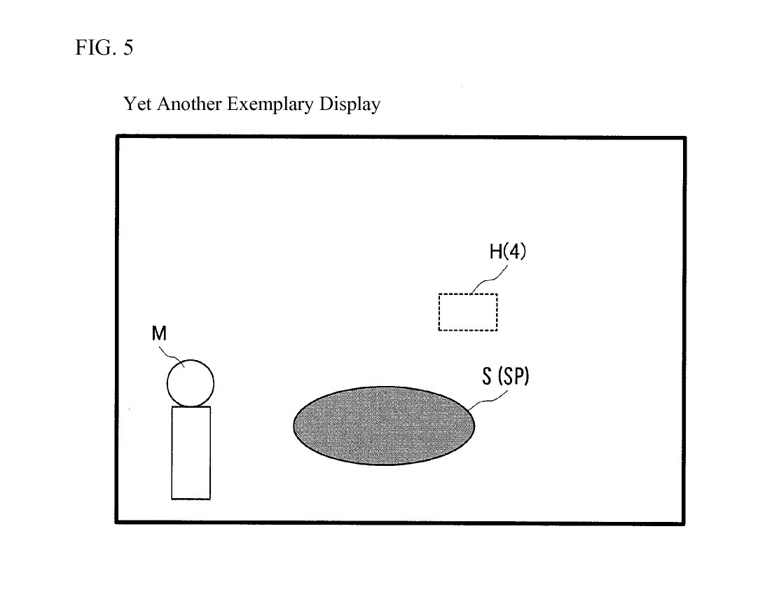

FIG. 5 shows a case, as yet another exemplary display, wherein the occupant location detecting sensor 10 is operating properly, and wherein the actual supply air arrival region SR essentially matches the displayed supply air arrival region S (the predicted supply air arrival region SP, predicted by the controller 2).

In the yet another exemplary display, M (the occupant location detected by the occupant location detecting sensor 10), indicated by the solid line, the elliptical region S (the predicted supply air arrival region SP, predicted by the controller 2), indicated by the solid line, and the square H (the blowing vent 4), indicated by the dotted line, are all displayed on the screen.

In the yet another exemplary display, the location M of the occupant that is displayed on the screen is the same as the actual location of the occupant, so it is understood that the occupant location detecting sensor 10 is operating properly. Moreover, the elliptical region S, indicated by the solid line, is essentially identical to the actual supply air arrival region SR, so it is understood that the predicted supply air arrival region SP, predicted by the controller 2, is also correct. If, despite this, the actual supply air arrival region SR can be considered to be unsuitable, then it is understood that there is a high probability that there is a problem with the control algorithm (for example, a failure to converge in the optimization calculation, phone into a local solution, or the like).

Note that even though the actual supply air arrival region SR is not displayed on the screen, it can be discerned, with some degree of ease, through feeling the temperature and air flow, or through actual measurements thereof.

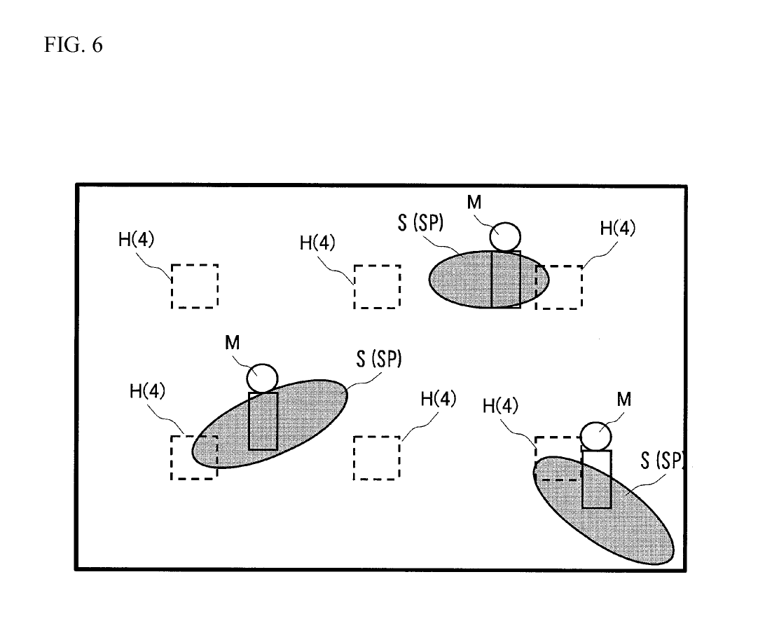

Moreover, although in the example described above the explanation was for a case wherein there was only a single blowing vent 4 in the subject space 3 that is subject to air-conditioning control, in reality there is a large number of blowing vents 4. For the blowing vents 4, which exist in this large number, the occupant location M(x, y), detected by the occupant location detecting sensor 10, and the predicted supply air arrival region SP, predicted by the controller 2, are displayed simultaneously on the screen, as illustrated in the exemplary display, the another exemplary display, and the yet another exemplary display (referencing FIG. 6).

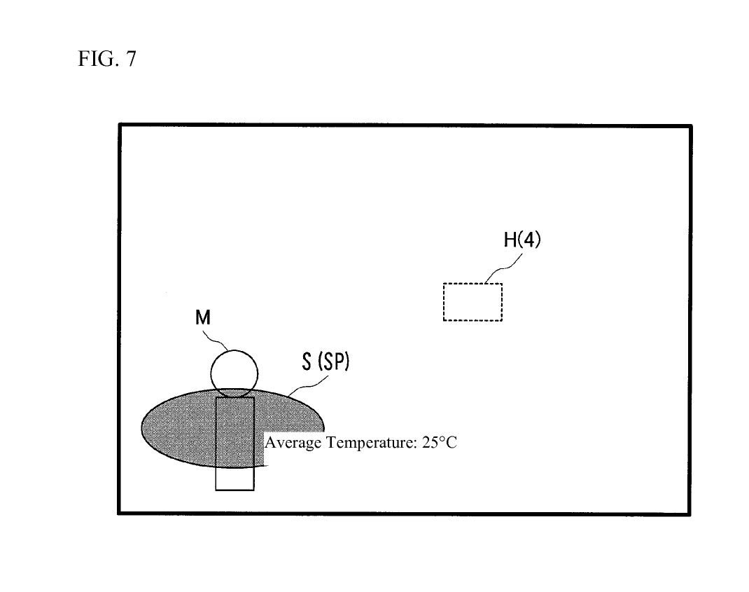

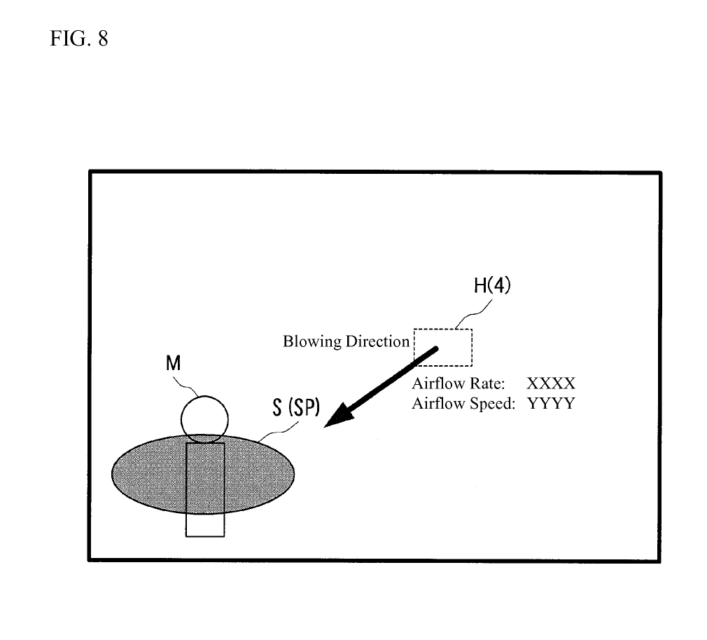

In the example set forth above, the occupant location M(x, y), detected by the occupant location detecting sensor 10, and the location of the blowing vent 4 are displayed on the screen together with the predicted supply air arrival region SP, predicted by the controller 2, but an average temperature of the predicted supply air arrival region SP may be displayed on the screen instead (referencing FIG. 7), or the air flow rate, airflow speed, and airflow direction may be displayed for each individual blowing vent 4 (referencing FIG. 8).

Moreover, an airflow speed distribution for the subject space 3 may be displayed on the screen, and the range of supply air arrival regions that can be achieved by adjustments by the controller 2 may be displayed on the screen. However, because it will change depending on the actual conditions (the air flow and temperature, a rough ballpark range that is determined by the variable angle of the blowing vent 4 may be displayed as a range over which the supply air arrival region may be achieved.

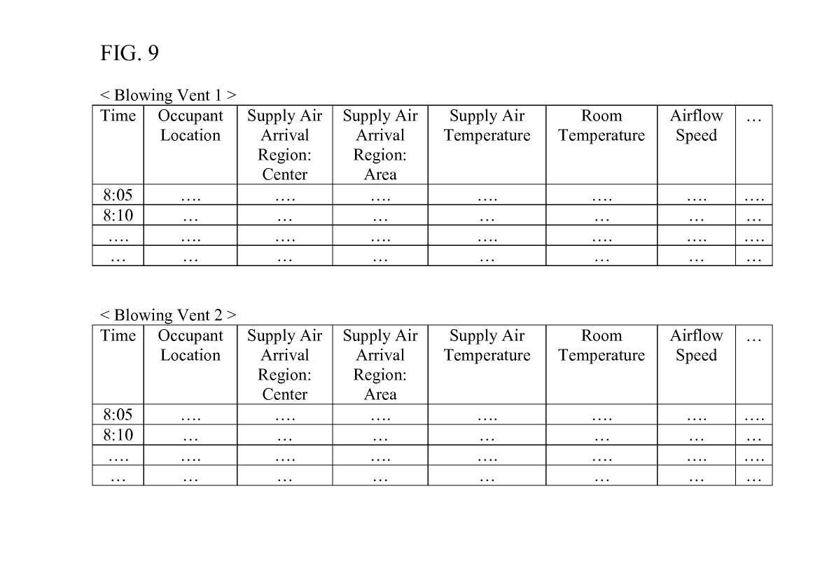

Moreover, for each blowing vent 4, time-series data that includes occupant locations M(x, y) detected by the occupant location detecting sensor 10, and the predicted supply air arrival region SP, predicted by the controller 2, may be displayed. For example, as illustrated in FIG. 9, for each blowing vent 4, the occupant locations M(x, y), detected by the occupant location detecting sensor 10, the predicted supply air arrival region SP (the supply air arrival region center and supply air arrival region area), the supply air temperature, the room temperature, the airflow speed, and the like, are stored as time-series data, and this stored time-series data can be displayed on the screen as necessary.

The various types of displays on the displaying device 11 according to the present invention are performed through a display processing portion 11A that is a processing function of a CPU. This displaying processing portion 11A corresponds to the display in the present disclosure.

### Extended Examples

While the present disclosure has been explained above in reference to the examples, the present disclosure is not limited to the examples set forth above. The structures and details in the present disclosure may be varied in a variety of ways, as can be understood by one skilled in the art, within the scope of technology in the present disclosure.

1. A displaying device used in an air-conditioning system comprising:
a blowing vent with a variable airflow direction, that blows conditioned air, as supply air, into a subject space that is subject to air-conditioning;
an occupant location detecting unit that detects a location of an occupant within the subject space;
a controller that predicts, following a guideline that has been established in advance, an arrival region for the supply air so as to include the location of an occupant detected by the occupant location detecting unit, and adjusts at least a flow direction of the blowing vent so as to include the location of an occupant detected by the occupant location detecting unit; and
a display that displays simultaneously, on a screen, the occupant location detected by the occupant location detecting unit and a predicted supply air arrival region, predicted by the controller.

2. The displaying device as set forth in claim 1, wherein:
the display displays, on a screen, a location of the blowing vent.

3. The displaying device as set forth in claim 1, wherein:
the display displays, on a screen, an average temperature of the predicted supply air arrival region.

4. The displaying device as set forth in claim 1, wherein:
the display displays, on a screen, time-series data including at least the occupant location detected by the occupant location detecting unit and the predicted supply air arrival region that has been predicted by the controller, for each of the blowing vents.

5. The displaying device as set forth in claim 1, wherein:
the display displays, on a screen, an airflow speed distribution within the subject space.

6. The displaying device as set forth in claim 1, wherein:
the display displays, on a screen, a range of supply air arrival regions that are achieved by adjustments by the controller.

7. The displaying device as set forth in claim 1, wherein:
the display displays, on a screen, a flow rate, an airflow speed, and an airflow direction of the supplied air from each blowing vent.

8. A displaying method applied to an air-conditioning system comprising a blowing vent with a variable airflow direction, for blowing conditioned air, as supply air, into a subject space that is subject to air-conditioning, occupant location detecting unit for detecting s location of an occupant within the subject space, and a controller for predicting, following a guideline that has been established in advance, an arrival region for the supply air so as to include a location of an occupant detected by the occupant location detecting unit, and for adjusting at least a flow direction of the blowing vent so as to include a location of an occupant detected by the occupant location detecting unit, the method comprising:
a displaying step for displaying simultaneously, on a screen, the occupant location detected by the occupant location detecting unit and a predicted supply air arrival region, predicted by the controller.
